(19) United States
(12) Patent Application Publication
(10) Pub. No.: US 2021/0201272 A1
(43) Pub. Date: Jul. 1, 2021

(54) FAULT REPORT AND REPAIR INTELLIGENT CONTROL SYSTEM

(71) Applicant: HEFEI HDB INFORMATION TECHNOLOGY CO., LTD., Anhui (CN)

(72) Inventors: Chen YU, Anhui (CN); Yanli KONG, Anhui (CN)

(73) Assignee: HEFEI HDB INFORMATION TECHNOLOGY CO., LTD., Anhui (CN)

(21) Appl. No.: 16/307,487

(22) PCT Filed: Oct. 31, 2018
(86) PCT No.: PCT/CN2018/112950

§ 371 Date: Dec. 6, 2018

(30) Foreign Application Priority Data
Aug. 23, 2018 (CN) 201810966521.0

(51) Int. Cl. G06Q 10/00; G01M 99/00; G05B 23/02

(52) U.S. Cl. CPC G06Q 10/20; G05B 23/0259; G01M 99/005

(57) ABSTRACT

The present application discloses a fault report and repair intelligent control system; information regularization module, configured to formulate a time level of the target faulty equipment based on the total operating hours, the operating hours of the current date, and the fault duration; fault regularization module, configured to formulate a fault level of the target faulty equipment based on the fault type; damage regularization module, configured to determine the damage level of the target faulty equipment based on the total number of faults of the target faulty equipment and the time interval from the last fault; intelligent control module, configured to formulate a fault repair strategy for the target faulty equipment. The present application analyzes and classifies the fault conditions of the faulty equipment, by collecting actual fault information, such as the number of faults of the faulty equipment, the fault time, and the fault type, and selects different repair methods according to the analysis result. On the one hand, it improves the overall and effective monitoring of the fault condition of the faulty equipment in the working process, on the other hand, it improves the repairing effect on the faulty equipment, and is beneficial to ensure the maintenance efficiency of the faulty equipment.

This application claims priority to Chinese Patent Application No. 201810966521.0, filed to the Chinese Patent Office on Aug. 23, 2018, entitled “FAULT REPORT AND REPAIR INTELLIGENT CONTROL SYSTEM”, the entire disclosure of which is incorporated herein by reference.

### BACKGROUND

### Technical Field

The present invention relates to the technical field of fault repair systems, and in particular, to fault report and repair intelligent control system.

### Background Art

The maintenance service company mainly adopts the paper repair work order. After receiving the repair call from the reporter, the fault report information is manual entried, and the relevant staff sends the repair work order to the maintenance staff after receiving it. Then the maintenance staff repairs the faulty equipment, and the reporter signs after completion. The existing fault report and repair system is not intelligent enough to determine the fault level of the faulty equipment according to the actual fault condition, so that it is difficult to select the adaptive maintenance staff according to the actual state of the faulty equipment, which not only reduces the accuracy of repair process, and reduces the accuracy of fault type determination of the faulty equipment, which hinders the improvement of the faulty equipment maintenance efficiency, and it is difficult to guarantee the repair effect on the faulty equipment.

### SUMMARY OF THE INVENTION

Based on the technical problems existing in the background art, the present application proposes a fault report and repair intelligent control system.

The fault report and repair intelligent control system proposed by the application includes: information regularization module, configured to obtain a total operating hours of the target faulty equipment, operating hours of the current date, and a fault duration, and formulate a time level of the target faulty equipment based on the total operating hours, the operating hours of the current date, and the fault duration;

fault regularization module, configured to acquire a fault type of the target faulty equipment, and formulate a fault level of the target faulty equipment based on the fault type;

damage regularization module, configured to acquire the total number of faults of the target faulty equipment and the time interval to the last fault, and determine the damage level of the target faulty equipment based on the total number of faults of the target faulty equipment and the time interval from the last fault;

intelligent control module, configured to acquire a time level, a fault level, and a damage level of the target faulty equipment, and formulate a fault repair strategy for the target faulty equipment based on the foregoing time level, fault level, and damage level.

Preferably, there are a first parameter t₁₁ and a second parameter t₂₂ stored in the information regularization module, where t₁₁<t₂₂;

The information regularization module is specifically configured to:

obtain a total operating hours of the target faulty equipment, operating hours of the current date, and a fault duration, which are respectively recorded as t₁, t₂, and t₃;

Calculate the time parameter t of the target faulty equipment according to the following formula, which is:

t=at₁+bt₂+ct₃;

Comparing the time parameter t of the target faulty equipment with the first parameter t₁₁ and the second parameter t₂₂ respectively:

When t≤t₁₁, the target faulty equipment is set to be the first time level;

When t₁₁<t<t₂₂, the target faulty equipment is set to the second time level;

When t≥t₂₂, the target faulty equipment is set to a third time level;

where a, b, c are all preset values.

Preferably, a light fault type set, there are a general fault type set, and a severe fault type set stored in the fault regularization module;

The fault regularization module is specifically configured to:

obtain the fault type of the target faulty equipment;

respectively match the fault type of the target faulty equipment with the light fault type set, the general fault type set, and the severe fault type set:

when the fault type of the target faulty equipment is successfully matched with the light fault type set successfully, the target faulty equipment is determined to be the first fault level;

when the fault type of the target faulty equipment is successfully matched with the general fault type set, the target faulty equipment is determined to be the second fault level;

when the fault type of the target faulty equipment is successfully matched with the serious fault type set, the target faulty equipment is determined to be the third fault level.

Preferably, there are preset number of times T₀ and a preset time interval W₀ stored in the damage regularization module;

The damage regularization module is specifically configured to:

obtain the total number of faults of the target faulty equipment and the interval to the last fault, which respectively recorded as T and W;

compare the total number of faults of the target faulty equipment T with the preset number of times T₀, and the time interval to the last fault W with a preset time interval W₀ respectively:

when T≥T₀, W≤W₀, the target faulty equipment is determined to be the third damage level;

when T≥T₀, W>W₀, the target faulty equipment is determined to be the second damage level;

when T<T₀, W≤W₀, the target faulty equipment is determined to be the second damage level;

when T<T₀, W>W₀, the target faulty equipment is set to the first damage level.

Preferably, the intelligent control module is specifically configured to:

obtain the time level, fault level, and damage level of the target faulty equipment;

when the time level, fault level, and damage level of the target faulty equipment are all at the third level, an emergency fault repair strategy is formulated for the target faulty equipment;

when at least one of the time level, the fault level, and the damage level of the target faulty equipment is at third level, a serious fault repair strategy is formulated for the target faulty equipment;

when the time level, at least one of the fault level, and the damage level of the target faulty equipment is at second level, a general fault repair strategy is formulated for the target faulty equipment;

when the time level, fault level, and damage level of the target faulty equipment are neither the second level nor the third level, a light fault repair strategy is formulated for the target faulty equipment;

wherein, the emergency fault repair strategy is that: sending the fault information of the target faulty equipment to the superior supervisory department and the regional supervisory department, and the information sending frequency is P₁;

the serious fault repairing strategy is that: sending the fault information of the target faulty equipment to the superior supervisory department, and the information sending frequency is P₁;

the general fault repairing strategy is: sending the fault information of the target faulty equipment to the superior supervisory department, and the information sending frequency is P₂;

the light fault repairing strategy is: sending the fault information of the target faulty equipment to the superior supervisory department, and the information sending frequency is P₃;

P₁>P₂>P₃.

The fault report and repair intelligent control system, proposed by the present application, analyzes and classifies the fault conditions of the faulty equipment, by collecting actual fault information, such as the number of faults of the faulty equipment, the fault time, and the fault type, and selects different repair methods according to the analysis result. On the one hand, it improves the overall and effective monitoring of the fault condition of the faulty equipment in the working process, on the other hand, it improves the repairing effect on the faulty equipment, and is beneficial to ensure the maintenance efficiency of the faulty equipment.

The present application determines the fault condition of the faulty equipment from three aspects of the time level, the fault level and the damage level, to determine the degree of urgency of the faulty equipment to be repaired from the fault time, the total number of faults, the fault duration of the faulty equipment, and the like., seek the technical strength required for the repair of the equipment from the fault type of the faulty equipment, and select different fault repair strategy for the faulty equipment by combining the urgency of the faulty equipment to be repaired and the technical strength required for repair. The strategy is specifically to send information to different supervisory departments and at different frequencies, so that the supervisory department can quickly and accurately take countermeasures according to comprehensive repair information, to ensure the maintenance efficiency and maintenance effect of the faulty equipment.

### BRIEF DESCRIPTION OF DRAWING

FIG. 1 is a schematic structural diagram of a fault report and repair intelligent control system.

### DETAILED DESCRIPTION OF THE INVENTION

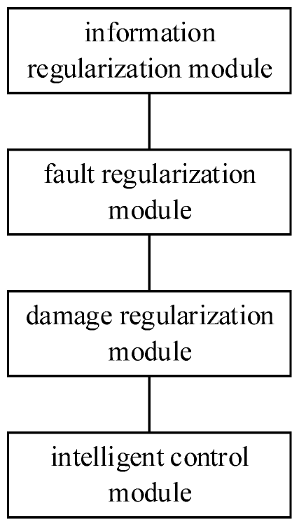

As shown in FIG. 1, FIG. 1 is a schematic structural diagram of a fault report and repair intelligent control system.

Refer to FIG. 1, the fault report and repair intelligent control system proposed by the application includes:

information regularization module, configured to obtain a total operating hours of the target faulty equipment, operating hours of the current date, and a fault duration, and formulate a time level of the target faulty equipment based on the total operating hours, the operating hours of the current date, and the fault duration;

In a present embodiment, there are a first parameter t₁₁ and a second parameter t₂₂ stored in the information regularization module, where t₁₁<t₂₂;

the information regularization module is specifically configured to:

obtain a total operating hours of the target faulty equipment, operating hours of the current date, and a fault duration, which are respectively recorded as t₁, t₂, and t₃;

calculate the time parameter t of the target faulty equipment according to the following formula, which is:

t=at₁+bt₂+ct₃;

by calculating the time parameter t of the target faulty equipment, it is advantageous to determine the urgency of the target faulty equipment in combination with the working life and the fault duration of the target faulty equipment, thereby improving the maintenance efficiency of the target faulty equipment;

comparing the time parameter t of the target faulty equipment with the first parameter t₁₁ and the second parameter t₂₂ respectively:

when t≤t₁₁, it indicates that the time parameter of the target faulty equipment is small, then the target faulty equipment is set to be the first time level;

when t₁₁<t<t₂₂, it indicates that the time parameter of the target faulty equipment is moderate, then the target faulty equipment is set to the second time level;

when t≥t₂₂, it indicates that the time parameter of the target faulty equipment is large, then the target faulty equipment is set to a third time level;

where a, b, c are all preset values.

Fault regularization module, configured to acquire a fault type of the target faulty equipment, and formulate a fault level of the target faulty equipment based on the fault type;

In a present embodiment, there are a light fault type set, a general fault type set, and a severe fault type set stored in the fault regularization module;

The fault regularization module is specifically configured to:

obtain the fault type of the target faulty equipment;

respectively match the fault type of the target faulty equipment with the light fault type set, the general fault type set, and the severe fault type set:

when the fault type of the target faulty equipment is successfully matched with the light fault type set successfully, the target faulty equipment is determined to be the first fault level;

when the fault type of the target faulty equipment is successfully matched with the general fault type set, the target faulty equipment is determined to be the second fault level;

when the fault type of the target faulty equipment is successfully matched with the serious fault type set, the target faulty equipment is determined to be the third fault level.

Damage regularization module, configured to acquire the total number of faults of the target faulty equipment and the time interval to the last fault, and determine the damage level of the target faulty equipment based on the total number of faults of the target faulty equipment and the time interval from the last fault;

In a present embodiment, there are preset number of times T₀ and a preset time interval W₀ stored in the damage regularization module;

The damage regularization module is specifically configured to:

obtain the total number of faults of the target faulty equipment and the interval to the last fault, which respectively recorded as T and W;

compare the total number of faults of the target faulty equipment T with the preset number of times T₀, and the time interval to the last fault W with a preset time interval W0 respectively:

when T≥T₀, W≤W₀, it indicates that the target faulty equipment has a large number of faults and the time interval from the last fault is short, so the target faulty equipment needs to be repaired in a short time, then the target faulty equipment is determined to be the third damage level;

when T≥T₀, W>W₀, it indicates that the target faulty equipment has more faults, then the target faulty equipment is determined to be the second damage level;

when T<T₀, W≤W₀, it indicates that the target faulty equipment has a shorter time interval from the last fault, then the target faulty equipment is determined to be the second damage level;

when T<T₀, W>W₀, it indicates that the target faulty equipment has fewer faults and has a longer time interval from the last fault, then the target faulty equipment is set to the first damage level.

By determining the damage level according to the total number of faults and the time interval from the last fault of the target faulty equipment, the urgency of the target faulty equipment to be repaired can be divided, so that the fault repair plan can be selected for the target.

Intelligent control module, configured to acquire a time level, a fault level, and a damage level of the target faulty equipment, and formulate a fault repair strategy for the target faulty equipment based on the foregoing time level, fault level, and damage level.

In a present embodiment, the intelligent control module is specifically configured to: obtain the time level, fault level, and damage level of the target faulty equipment; when the time level, fault level, and damage level of the target faulty equipment are all at the third level, an emergency fault repair strategy is formulated for the target faulty equipment; when at least one of the time level, the fault level, and the damage level of the target faulty equipment is at third level, a serious fault repair strategy is formulated for the target faulty equipment;

when the time level, at least one of the fault level, and the damage level of the target faulty equipment is at second level, a general fault repair strategy is formulated for the target faulty equipment;

when the time level, fault level, and damage level of the target faulty equipment are neither the second level nor the third level, a light fault repair strategy is formulated for the target faulty equipment;

wherein, the emergency fault repair strategy is that: sending the fault information of the target faulty equipment to the superior supervisory department and the regional supervisory department, and the information sending frequency is P₁;

the serious fault repairing strategy is that: sending the fault information of the target faulty equipment to the superior supervisory department, and the information sending frequency is P₁;

the general fault repairing strategy is: sending the fault information of the target faulty equipment to the superior supervisory department, and the information sending frequency is P₂;

the light fault repairing strategy is: sending the fault information of the target faulty equipment to the superior supervisory department, and the information sending frequency is P₃;

P₁>P₂>P₃;

According to the different fault conditions of the target faulty equipment, the fault information is sent to different supervisory departments and sent to the relevant supervisory departments at different frequencies, to ensure the validity and pertinence of the information transmission, thereby facilitating the relevant supervisory departments to take effective control measures, timely repair and maintenance of faulty equipment to ensure the effectiveness and efficiency of maintenance.

The fault report and repair intelligent control system, proposed by the present application, analyzes and classifies the fault conditions of the faulty equipment, by collecting actual fault information, such as the number of faults of the faulty equipment, the fault time, and the fault type, and selects different repair methods according to the analysis result. On the one hand, it improves the overall and effective monitoring of the fault condition of the faulty equipment in the working process, on the other hand, it improves the repairing effect on the faulty equipment, and is beneficial to ensure the maintenance efficiency of the faulty equipment.

The present application determines the fault condition of the faulty equipment from three aspects of the time level, the fault level and the damage level, to determine the degree of urgency of the faulty equipment to be repaired from the fault time, the total number of faults, the fault duration of the faulty equipment, and the like., seek the technical strength required for the repair of the equipment from the fault type of the faulty equipment, and select different fault repair strategy for the faulty equipment by combining the urgency of the faulty equipment to be repaired and the technical strength required for repair. The strategy is specifically to send information to different supervisory departments and at different frequencies, so that the supervisory department can quickly and accurately take countermeasures according to comprehensive repair information, to ensure the maintenance efficiency and maintenance effect of the faulty equipment.

The above is only the preferred embodiment of the present application, but the scope of protection of the present application is not limited thereto, and any equivalents or modifications of the technical solutions of the present application and the application concept thereof should be included in the scope of the present application within the scope of the technical scope of the present application.

What is claimed is:

1. A fault report and repair intelligent control system, characterized by comprising:
information regularization module, configured to obtain a total operating hours of a target faulty equipment, operating hours of a current date, and a fault duration, and formulate a time level of the target faulty equipment based on the total operating hours, the operating hours of the current date, and the fault duration;
fault regularization module, configured to acquire a fault type of the target faulty equipment, and formulate a fault level of the target faulty equipment based on the fault type;
damage regularization module, configured to acquire a total number of faults of the target faulty equipment and a time interval to a last fault, and determine a damage level of the target faulty equipment based on the total number of faults of the target faulty equipment and the time interval from the last fault;
intelligent control module, configured to acquire a time level, a fault level, and a damage level of the target faulty equipment, and formulate a fault repair strategy for the target faulty equipment based on the time level, fault level, and damage level.

2. The fault report and repair intelligent control system according to claim 1, characterized in that, there are a first parameter t₁₁ and a second parameter t₂₂ stored in the information regularization module, where t₁₁<t₂₂;
the information regularization module is specifically configured to:
obtain the total operating hours of the target faulty equipment, the operating hours of the current date, and the fault duration, which are respectively recorded as t₁, t₂, and t₃;
calculate a time parameter t of the target faulty equipment according to the following formula, which is:
t=at₁+bt₂+ct₃;
comparing the time parameter t of the target faulty equipment with the first parameter t₁₁ and the second parameter t₂₂ respectively:
when t≤t₁₁, the target faulty equipment is set to be a first time level;
when t₁₁<t<t₂₂, the target faulty equipment is set to a second time level;
when t≥t₂₂, the target faulty equipment is set to a third time level;
where a, b, c are all preset values.

3. The fault report and repair intelligent control system according to claim 2, characterized in that, there are a light fault type set, a general fault type set, and a severe fault type set stored in the fault regularization module;
the fault regularization module is specifically configured to:
obtain the fault type of the target faulty equipment;
respectively match the fault type of the target faulty equipment with the light fault type set, the general fault type set, and the severe fault type set:
when the fault type of the target faulty equipment is successfully matched with the light fault type set, the target faulty equipment is determined to be the first fault level;
when the fault type of the target faulty equipment is successfully matched with the general fault type set, the target faulty equipment is determined to be the second fault level;
when the fault type of the target faulty equipment is successfully matched with the serious fault type set, the target faulty equipment is determined to be the third fault level.

4. The fault report and repair intelligent control system according to claim 3, characterized in that, there are a preset number of times T₀ and a preset time interval W₀ stored in the damage regularization module;
the damage regularization module is specifically configured to:
obtain the total number of faults of the target faulty equipment and the interval to the last fault, respectively recorded as T and W;
compare the total number of faults of the target faulty equipment T with the preset number of times T₀, and the time interval to the last fault W with the preset time interval W₀ respectively:
when T≥T₀, W≤W₀, the target faulty equipment is determined to be the third damage level;
when T≥T₀, W>W₀, the target faulty equipment is determined to be the second damage level;
when T<T₀, W≤W₀, the target faulty equipment is determined to be the second damage level;
when T<T₀, W>W₀, the target faulty equipment is set to the first damage level.

5. The fault report and repair intelligent control system according to claim 4, characterized in that, the intelligent control module is specifically configured to:
obtain the time level, fault level, and damage level of the target faulty equipment;
when the time level, fault level, and damage level of the target faulty equipment are all at the third level, an emergency fault repair strategy is formulated for the target faulty equipment;
when at least one of the time level, the fault level, and the damage level of the target faulty equipment is at third level, a serious fault repair strategy is formulated for the target faulty equipment;
when at least one of the time level, the fault level, and the damage level of the target faulty equipment is at second level, a general fault repair strategy is formulated for the target faulty equipment;
when the time level, fault level, and damage level of the target faulty equipment are neither the second level nor the third level, a light fault repair strategy is formulated for the target faulty equipment;
wherein, the emergency fault repair strategy is: sending a fault information of the target faulty equipment to a superior supervisory department and a regional supervisory department, and a information sending frequency is P₁;
the serious fault repairing strategy is: sending a fault information of the target faulty equipment to the superior supervisory department, and the information sending frequency is P₁;
the general fault repairing strategy is: sending a fault information of the target faulty equipment to the superior supervisory department, and the information sending frequency is P₂;
the light fault repairing strategy is: sending a fault information of the target faulty equipment to the superior supervisory department, and the information sending frequency is P₃;
P₁>P₂>P₃.
